(19) United States
(12) Patent Application Publication
(10) Pub. No.: US 2004/0260698 A1
(43) Pub. Date: Dec. 23, 2004

(54) Method and apparatus for accessing information in a private database

(76) Inventor: Bruce Daniel MacMillan, Roswell, GA (US)

Correspondence Address: KIRKPATRICK & LOCKHART LLP, 535 SMITHFIELD STREET, PITTSBURGH, PA, 15222, US

(21) Appl. No.: 10/601,812

(22) Filed: Jun. 23, 2003

(51) Int. Cl. G06F 17/30

(52) U.S. Cl. 707/9

(57) ABSTRACT

A method for accessing information in a private database is disclosed. The method includes, at an e-mail server, receiving a request from a wireless communication device to access the information in the private database, sending a query to retrieve the information, receiving a response to the query, where the response includes the information, and sending the information to the wireless communication device.

### BACKGROUND

The present application is related, generally, to a private information exchange system. During the ordinary course of business, there are many instances where a person needs information, and needs the information in a timely manner. In some instances, the person may possess a hard copy of the information. However, for people such as salespeople or field personnel, it may be impractical to possess a hard copy of all of the information that they may require. In other instances, the person may simply place a telephone call to obtain the information. However, there are situations where placing a telephone call to obtain the information is not a desirable option. For example, if the person is participating in an important meeting, the call may be disruptive to others participating in the meeting and the conversation may not provide the desired level of privacy. In yet other instances, the person may obtain the information from a particular website. However, the information needed by the person may be sensitive information such as, for example, confidential company information, that is not available from a website.

### SUMMARY

In one general respect, the present invention is directed to method for accessing information in a private database. According to one embodiment, the method includes, at an e-mail server, receiving a request from a wireless communication device to access the information in the private database, sending a query to retrieve the information, receiving a response to the query, where the response includes the information, and sending the information to the wireless communication device.

In another general respect, the present invention is directed to an apparatus for accessing information in a private database. According to one embodiment, the apparatus includes an e-mail server for accessing the private database. The e-mail server is configured for communication with a wireless communication device and includes an identification module for indentifying an e-mail address of the wireless communication device. The e-mail server also includes an authorization module for authorizing the e-mail server to access the private database and forward the information to the wireless communication device.

### DESCRIPTION OF THE DRAWINGS

FIG. 1 illustrates one embodiment of a private information exchange; and

FIG. 2 illustrates one embodiment of a process flow through the private information exchange of FIG. 1.

### DESCRIPTION

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

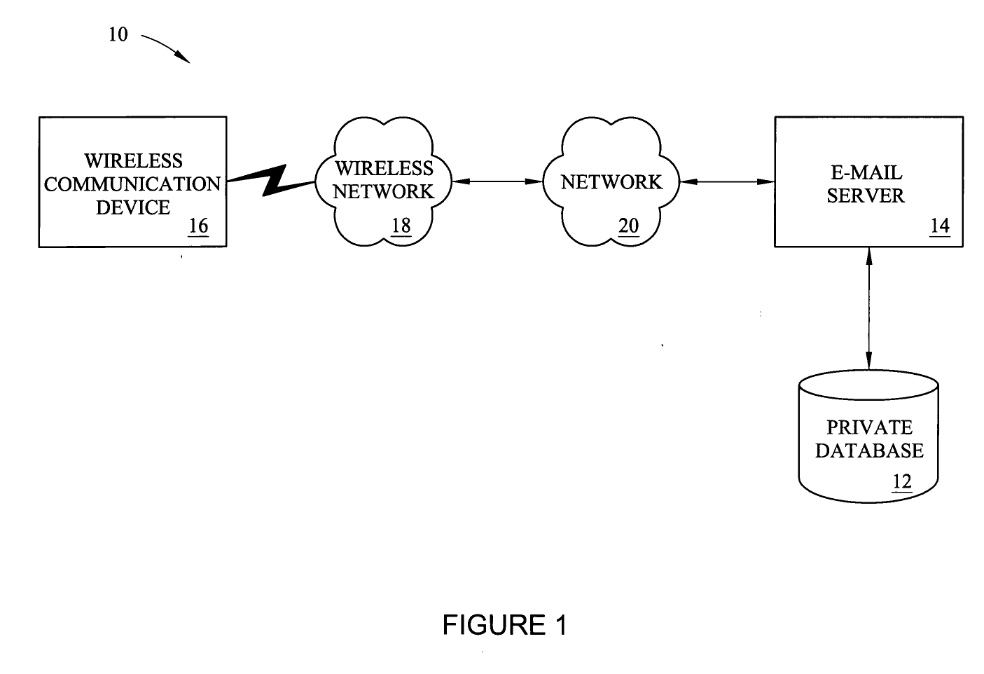

FIG. 1 illustrates one embodiment of a private information exchange 10. The private information exchange 10 may include a private database 12, an e-mail server 14 for accessing the private database 12, a wireless communication device 16, a wireless network 18, and a network 20 such as the Internet. The private database 12 and the e-mail server 14 may comprise a portion of an Intranet or an Extranet.

The private database 12 may include sensitive information such as, for example, confidential company information, that may only be accessible by people authorized to do so. As shown in FIG. 1, the private database 12 may be accessed through the e-mail server 14 by the wireless communication device 16 via the wireless network 18 and the Internet 20. According to one embodiment, the private database 12 may reside at a database server computer (not shown). According to another embodiment, the private database 12 may reside at the e-mail server 14.

The e-mail server 14 is configured for communication with the wireless communication device 16 and may include an identification module 22 and an authorization module 24. The identification module 22 may be used for identifying an e-mail address of the wireless communication device 16. The authorization module 24 may be used for authorizing the e-mail server 14 to access information in the private database 12 and forward the information to the wireless communication device 16.

The modules 22, 24 may be implemented as microcode configured into the logic of the e-mail server 14, or may be implemented as programmable microcode stored in electrically erasable programmable read only memories (EEPROMs). According to another embodiment, the modules 22, 24 may be implemented as software code to be executed by the e-mail server 14. The software code may be written in any suitable programming language using any suitable programming technique. For example, the software code may be written in C using procedural programming techniques, or in Java or C++ using object oriented programming techniques. The software code may be stored as a series of instructions or commands on a computer readable medium, such as a random access memory (RAM) or a read only memory (ROM), a magnetic medium such as a hard disk or a floppy disk, or an optical medium such as a CD-ROM.

The wireless communication device 16 may be any type of wireless communication device suitable for sending and receiving e-mail messages to and from the e-mail server 14. For example, the wireless communication device 16 may be one of a wireless telephone, a wireless pager and a wireless personal digital assistant.

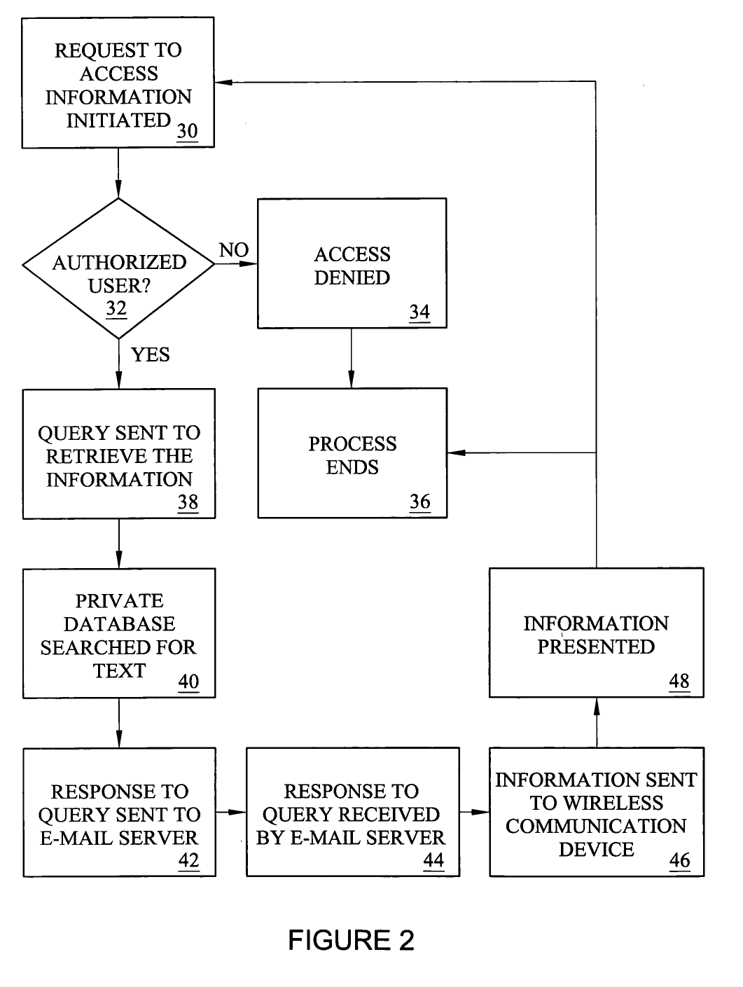

FIG. 2 illustrates one embodiment of a process flow through the private information exchange 10 of FIG. 1. The process starts at block 30, where a user of the wireless communication device 16 initiates a request to access information in the private database 12. The request may be initiated by using the wireless communication device 16 to create an e-mail and send the e-mail to the e-mail server 14. As is known in the art, the e-mail may be routed through one or more SMTP servers (not shown) and a POP3 server (not shown) while being sent from the wireless communication device 16 to the e-mail server 14.

From block 30, the process advances to block 32, where the e-mail server 14 receives the e-mail sent from the wireless communication device 16 and determines whether the user is authorized to access the private database 12. The e-mail server 14 may determine whether the user is authorized to access the private database 12 by analyzing the e-mail to identify the e-mail address of the wireless communication device 16, then comparing the identified e-mail address with a list of e-mail addresses of users authorized to access the private database 12. According to one embodiment, the list of e-mail addresses of users authorized to access the private database 12 may reside at the e-mail server 14. According to another embodiment, the list of e-mail addresses of users authorized to access the private database 12 may reside external to the e-mail server 14.

The identification module 22 may identify the e-mail address of the wireless communication device 16 by analyzing the “from” address of the e-mail received from the wireless communication device 16. The authorization module 24 may compare the identified e-mail address with the list of e-mail addresses of users authorized to access the private database 12. If the list of e-mail addresses includes the e-mail address of the wireless communication device 16, the e-mail server 14 deems the user to be authorized to access the private database 12.

From block 32, the process may advance to block 34 or to block 38. If the e-mail server 14 determines that the user is not authorized to access the private database 12, the process advances from block 32 to block 34, where the e-mail server 14 denies the user access to the private database 12. From block 34, the process advances to block 36, where the process is ended. However, if the e-mail server 14 determines that the user is authorized to access the private database 12, the process advances from block 32 to block 38, where the e-mail server 14 generates and sends a query to retrieve the information. The e-mail server 14 may analyze the e-mail received from the wireless communication device 16 to identify certain text in the e-mail, then generate the query based on the identified text. The text may be associated with the requested information, and may be in the form of, for example, a word, an acronym, a phrase, a number, a letter and a number, or any combination thereof.

From block 38, the process advances to block 40, where the private database 12 is searched for the text associated with the requested information. From block 40, the process advances to block 42, where a response to the query is generated and communicated back to the e-mail server 14. According to one embodiment, the response may be in the form of a document that includes the identified text. According to another embodiment, the response may be in the form of a list of documents that include the identified text, and the documents may be listed by order of relevance as is known in the art. According to another embodiment, the response may be in the form of a message indicating that no documents containing the identified text were found.

From block 42, the process advances to block 44, where the e-mail server 14 receives the information included in the response. From block 44, the process advances to block 46, where the information is sent from the e-mail server 14 to the wireless communication device 16. The information may be sent from the e-mail server 14 to the wireless communication device 16 via the Internet 20 and the wireless network 18, and may be in the form of an e-mail, where the body of the e-mail includes the information. As is known in the art, the e-mail may be routed through one or more SMTP servers (not shown) and a POP3 server (not shown) while being sent from the e-mail server 14 to the wireless communication device 16. From block 46, the process advances to block 48, where the wireless communication device 16 receives the e-mail and presents the information to the user.

From block 48, the process may advance to block 30 or to block 36. If the presented information is deemed by the user to be sufficient, the process advances from block 48 to block 36, where the process is ended. However, if the displayed information is not deemed by the user to be sufficient, the process advances from block 48 to block 30, where the user of the wireless communication device 16 initiates a second request to access information in the private database 12. From block 30, the process may advance through blocks 32-48 as described hereinabove, and the process from block 30 through block 48 and back to block 30 may be repeated as many times as the user deems necessary.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

What is claimed is:

1. A method for accessing information in a private database, the method comprising:
at an e-mail server,
receiving a request from a wireless communication device to access the information in the private database;
sending a query to retrieve the information;
receiving a response to the query, wherein the response includes the information; and
sending the information to the wireless communication device.

2. The method of claim 1, wherein receiving the request includes receiving an e-mail from the wireless communication device.

3. The method of claim 2, wherein receiving the e-mail from the wireless communication device includes receiving the e-mail from one of a wireless telephone, a wireless pager and a wireless personal digital assistant.

4. The method of claim 1, wherein sending the query includes authorizing access to the private database.

5. The method of claim 4, wherein authorizing access to the private database includes identifying an e-mail address of the wireless communication device.

6. The method of claim 5, wherein authorizing access to the private database includes comparing the e-mail address of the wireless communication device with a list of authorized e-mail addresses.

7. The method of claim 6, wherein authorizing access to the private database includes confirming that the list of authorized e-mail addresses includes the e-mail address of the wireless communication device.

8. The method of claim 2, wherein sending the query includes identifying text in the e-mail.

9. The method of claim 8, wherein identifying text in the e-mail includes identifying a word associated with the information.

10. The method of claim 9, wherein identifying the word in the e-mail includes identifying an acronym associated with the information.

11. The method of claim 8, wherein identifying text in the e-mail includes identifying a phrase associated with the information.

12. The method of claim 8, wherein identifying text in the e-mail includes identifying a number associated with the information.

13. The method of claim 8, wherein identifying text in the e-mail includes identifying a letter and a number associated with the information.

14. The method of claim 1, wherein receiving the response includes receiving the information.

15. The method of claim 1, wherein sending the information to the wireless communication device includes sending an e-mail to the wireless communication device.

16. The method of claim 1, further comprising:
at the e-mail server,
receiving a second request from the wireless communication device, wherein the second request is for accessing additional information;
sending a second query, wherein the second query is for retrieving the additional information;
receiving a response to the second query, wherein the response to the second query includes the additional information; and
sending the additional information to the wireless communication device.

17. An apparatus for accessing information in a private database, the apparatus comprising:
an e-mail server for accessing the private database, wherein the e-mail server is configured for communication with a wireless communication device and includes:
an identification module for identifying an e-mail address of the wireless communication device; and
an authorization module for authorizing the e-mail server to access the private database and forward the information to the wireless communication device.

18. The apparatus of claim 17, wherein the e-mail server comprises a portion of an Intranet.

19. The apparatus of claim 17, wherein the e-mail server comprises a portion of an Extranet.

20. A computer-readable medium having stored thereon a set of instructions which, when executed by a processor, cause the processor to:
identify an e-mail address of a wireless communication device; and
authorize an e-mail server to access information in a private database and forward the information to the wireless communication device.
